(19) United States
(12) Patent Application Publication
(10) Pub. No.: US 2026/0264513 A1
(43) Pub. Date: Sep. 10, 2026

(54) METHOD FOR CONTROLLING A DRIVE DEVICE FOR A WORKING MACHINE

(71) Applicant: ZF Friedrichshafen AG, Friedrichshafen (DE)

(72) Inventors: Nikolai EGLER, Riedhausen (DE); Joachim SAUTER, Berg (DE); Markus RIESTER, Wald (DE); Dieter BALZ, Wangen im Allgäu (DE); Raphael GONZALEZ, Leutkirch (DE)

(73) Assignee: ZF Friedrichshafen AG, Friedrichshafen (DE)

(21) Appl. No.: 19/557,849

(22) Filed: Mar. 5, 2026

(30) Foreign Application Priority Data
Mar. 6, 2025 (DE) 10 2025 108 506.4

(51) Int. Cl. B60K 23/04; B60K 17/16; B60K 17/34

(52) U.S. Cl. CPC B60K 23/04; B60K 17/165; B60K 17/34; B60K 2023/046

(57) ABSTRACT

A method is provided for controlling a drive device for a working machine having an engine for providing a driving force. The working machine has at least one lockable longitudinal differential for distributing the drive force of the engine to at least two lockable transverse differentials, a sensor device for detecting operating parameters that include rotational speeds of the output elements of the transverse differentials. A differential speed between the speeds of the output elements of each of the transverse differentials is determined and the longitudinal differential is locked when a longitudinal differential lock condition is met by at least one of the differential speeds reaching or exceeding a lock threshold value.

### RELATED APPLICATIONS

This application claims the benefit of and right of priority under 35 U.S.C. § 119 to German Patent Application no. 10 2025 108 506.4, filed on 6 Mar. 2025, the contents of which are incorporated herein by reference in its entirety.

### TECHNICAL FIELD

The present invention relates to a method for controlling a drive device for a working machine, to a control device for executing a method for controlling a drive device, to a drive device with a control device, and to a working machine with a drive device.

### BACKGROUND

Methods for controlling a working machine are known. With the increasing complexity of working machines and high-performance requirements for working machines, there is a need for methods that allow a working machine to be operated efficiently, reliably, and economically.

### SUMMARY

It is an object of the present invention to provide an improved method for controlling a drive device that enables reliable operation of the working machine.

The task is solved by a method for controlling a drive device of a working machine as disclosed herein. Advantageous further developments will be apparent from the present disclosure.

In a first aspect, a method for controlling a drive device for a working machine is provided. The working machine can be designed as a loader, tipper, or dump truck, for example an articulated dump truck. The drive device has an engine for providing a driving force. The drive device has at least one lockable longitudinal differential. The drive device has at least two lockable transverse differentials. The longitudinal differential is designed to distribute the drive force of the engine to at least two transverse differentials. Each of the transverse differentials is designed to distribute the drive force from one input element to two output elements. The output elements are designed to move the working machine. The drive device has a sensor device for detecting a plurality of operating parameters. The operating parameters include a rotational speed of the output elements of the transverse differentials, for example, each of the output elements of each of the transverse differentials. This may involve detecting at least one of measuring and ascertaining, for example by converting a detected rotational speed of another element of the drive device to the corresponding output element.

The working machine may have a working device. The work equipment may be configured to perform a work task, for example lifting and/or transporting a load. The work equipment may be designed as a loading area, for example a tipper body. The engine can be designed as an electric engine or an internal combustion engine, such as a diesel engine. The engine may have a drive shaft. The drive shaft can be mechanically connected to an input element of the longitudinal differential to apply a driving force.

At least one of the longitudinal differential and the transverse differentials may be designed as a bevel gear differential or planetary differential. The longitudinal differential may be designed as a planetary differential. The transverse differentials can be designed as bevel gear differentials. Each of the longitudinal differential and the transverse differentials may have one input element and two output elements. An output element of the longitudinal differential may be mechanically connected to an input element of one of the transverse differentials. The other output element of the longitudinal differential can be mechanically connected to an input element of another of the transverse differentials. Each of the output elements of the longitudinal differential can be mechanically connected to the input element of one of the transverse differentials via at least one of a cardan shaft and a gearbox, for example a spur gear. Each of the output elements of the transverse differential can be mechanically connected to a traction element of the working machine, for example, in a rotationally fixed manner or via a portal gear.

If two elements are mechanically connected, they are directly or indirectly coupled in such a way that movement of one element causes a reaction in the other element. For example, a mechanical connection can be provided by a form-fitting or friction-locking connection. The mechanical connection can correspond to the combing of corresponding teeth on the two elements. Additional elements, such as one or more spur gear stages, may be provided between the elements. A permanently rotationally fixed connection between two elements, on the other hand, is understood to be a connection in which the two elements are rigidly coupled to each other in all intended states of the gearbox. The elements can be individual components connected to each other in a rotationally fixed manner or can also be made in one piece. In contrast, a rotationally fixed connection between two elements can be selectively established or released via a switching element, such as a clutch or brake.

One of the transverse differentials can be assigned to each drivable axle unit, for example, a drivable front axle or a drivable rear axle. Each of the axle units may have one of the transverse differentials. Each of the axle units may have two traction elements. The working machine may have three axle units, for example. An axle unit may be designed as a drivable front axle. An axle unit may be designed as the first drivable rear axle. An axle unit may be designed as a second drivable rear axle. An output element of the longitudinal differential may be mechanically connected to the input element of the transverse differential of the drivable front axle. The other output element of the longitudinal differential may be mechanically connected to the input element of the transverse differential of the first drivable rear axle. The first drivable rear axle may be designed as a through-drive axle. The through-drive axle may have a through-drive output element. The through-drive output element may be mechanically connected to the input element of the transverse differential of the second rear axle, for example directly and without a longitudinal differential. The through-drive output element may be mechanically connected to the input element of the transverse differential of the second rear axle via an additional longitudinal differential.

The drive device may have a manual transmission. The manual transmission may be designed as a continuously variable transmission. The manual transmission may provide at least one gear ratio for forward travel and one gear ratio for reverse travel. The manual transmission may feature a longitudinal differential. The manual transmission and the longitudinal differential can be arranged in a common housing, for example a transmission housing.

The longitudinal differential and the transverse differentials can be designed to be lockable, for example, lockable via a switching element. The drive device may have a switching element for each differential. The switching element may be designed as a clutch, for example a multi-plate clutch. The switching element may be designed to be actuated or switched via an actuator. The actuator may be designed as a hydraulic or pneumatic actuator. A locking pressure may be applied to the switching element via the actuator. The switching element may be designed to close via the locking pressure, for example by increasing the locking pressure. By closing the switching element, the respective differential may be locked, for example completely, partially, and/or continuously. The longitudinal differential and the transverse differentials can be designed to be continuously lockable, for example by applying a target pressure. At least one of the longitudinal differential and the transverse differentials may be locked smoothly, for example by applying a pre-pressure and then reducing it to a holding pressure. After a short period of time, the locking pressure for actuating or closing the switching element for at least one of the longitudinal differential and the transverse differentials may be gently increased, for example via a pressure gradient, to a level for locking the respective differential.

When open, each of the transverse differentials can be set up to compensate for the rotational speed of the traction elements of the respective drive axle. Each of the transverse differentials can be set up in a locked state for synchronous load distribution or drive force distribution to the two traction elements of the respective axle unit, for example to reduce unwanted slippage between the traction elements or spinning of one of the traction elements. This leads to improved traction of the working machine.

When open, the longitudinal differential can be designed for distribution, for example load-dependent distribution, of the drive force to the transverse differentials. When locked, the longitudinal differential may be designed for synchronous load distribution or drive force distribution, for example to the two mechanically connected transverse differentials, for example the front axle and the first rear axle. This leads to improved traction of the working machine, for example in the event that all traction elements of an axle unit exhibit unwanted slip.

The sensor device may comprise at least one sensor, for example at least one of a speed sensor, a temperature sensor, a pressure sensor, a torque sensor, or an angle sensor. The sensor device may comprise a speed sensor for each output element of the transverse differentials, for example for detecting the speeds of each of the output elements of the transverse differentials. The sensor device may comprise at least four speed sensors, for example two speed sensors for the output elements of the transverse differential of the front axle and two speed sensors for the output elements of the transverse differential of the rear axle. The sensor device may have six speed sensors, for example two additional speed sensors for the output elements of the transverse differential of the second rear axle. The sensor device may comprise a speed sensor for each traction element, for example for detecting the speeds of the traction elements, such as the drivable axle units. The sensor device may comprise a speed sensor for each output element of the longitudinal differential for detecting the speed of the output elements of the longitudinal differential.

The method comprises determining a differential speed between the speeds of the respective output elements of the respective transverse differentials. Alternatively, or additionally, the method may comprise determining a difference in rotational speed between the rotational speeds of the respective output elements of the respective transverse differentials. The method involves locking the longitudinal differential when a longitudinal differential lock condition is met. The longitudinal differential lock condition is met when one of the differential speeds reaches or exceeds a lock threshold value. This provides automated locking and unlocking of the differentials, for example, the longitudinal differential and the at least two transverse differentials. The differentials no longer need to be operated manually. This allows differentials to be engaged as needed. Tire wear and/or component wear, for example on the differentials, is reduced. In addition, the method is versatile and can be adapted to configurations of different working machines.

The method may include detecting the rotational speeds of the output elements of each of the transverse differentials. The method may be configured to detect unwanted slip, for example between output elements of a transverse differential or between traction elements of an axle unit, when the longitudinal differential lock condition is met. The method may include determining the differential speed for each of the transverse differentials. The method may be configured to determine a number of differential speeds corresponding to the number of transverse differentials present in the drive device. The method may be set up to determine a differential speed at the drivable front axle, a differential speed at the drivable rear axle, and, if applicable, a differential speed at the drivable second rear axle. This allows the method for detecting the transverse differential or the axle unit at which unwanted slip occurs to be set up.

The method may include determining a difference in rotational speed between a rotational speed of an output element of one of the transverse differentials and a rotational speed of an output element of another of the transverse differentials. This allows the method for detecting unwanted slip to be set up for all traction elements of an axle unit together or for the spinning of a drivable axle.

The longitudinal differential lock condition can be met if at least one differential speed of one of the transverse differentials exceeds the lock threshold value. The longitudinal differential lock condition can be met if the differential speed of the output elements of different transverse differentials exceeds the lock threshold value. The lock threshold value can be set at different levels for the various transverse differentials or axle units. The lock threshold value may be higher than a differential speed that results between the two output elements of a transverse differential when the working machine is traveling around a curve, for example, in accordance with the intended use of the working machine.

If several longitudinal differentials are provided in the drive device, the method may be set up to first lock the longitudinal differential that is mechanically connected to the transverse differential for which the longitudinal differential lock condition is fulfilled. A single-track model can be used as a basis for controlling the locking function of the longitudinal differential. The method may include determining expected differential speeds, for example, due to the working machine traveling around a curve. The method may include determining a difference between the differential speeds and the expected differential speeds. The longitudinal differential lock condition may be met if one of the differential speeds reaches or exceeds a differential limit value.

In a further embodiment of the method, the longitudinal differential lock condition may be met if one of the differential speeds exceeds the lock threshold value for a longitudinal differential waiting time. The longitudinal differential waiting time can cover a period of time. The longitudinal differential waiting time may provide a period of time for verifying, for example by a control device, that the longitudinal differential lock condition has been met. The longitudinal differential waiting time may comprise an evaluation time for completing an evaluation, for example, by a control unit for executing the method, of whether the longitudinal differential lock condition is met. If the differential speed falls below the lock threshold value within the longitudinal differential waiting time, the method may be configured to determine that the longitudinal differential lock condition is not met.

In another embodiment of the method, the method may further include locking one of the transverse differentials for which a transverse differential lock condition is satisfied. The transverse differential lock condition may be satisfied for the transverse differential whose differential speed satisfies the longitudinal differential lock condition for a transverse differential waiting time.

The transverse differential lock condition may be satisfied for the transverse differential for which the differential speed reaches or exceeds the lock threshold value for the longitudinal differential waiting time and subsequently the transverse differential waiting time. The transverse differential waiting time may be a waiting time that elapses after the longitudinal differential is locked before one of the transverse differentials is closed. If the differential speed falls below the lock threshold value within the transverse differential waiting time, the method may be configured to determine that the transverse differential lock condition is not met. Unintended locking of at least one of the transverse differentials may be prevented. This allows transverse differentials to be activated as needed.

The transverse differential lock condition may be met when the differential speed of the respective transverse differential reaches an upper limit that is greater than the lock threshold value. This allows the method to be set up to lock a transverse differential with a particularly high differential speed before the transverse differential waiting time and/or longitudinal differential waiting time expires.

In another embodiment of the method, the method may further comprise ascertaining a differential speed gradient of the differential speeds. The method may include reducing the transverse differential waiting time to a reduced transverse differential waiting time when the differential speed gradient reaches or exceeds a gradient lock threshold value. The differential speed gradient may be formed from a change in the differential speed per time. By reducing the transverse differential waiting time, the transverse differential may be locked earlier. The transverse differential lock condition may be met when the differential speed gradient reaches or exceeds the gradient lock threshold value. This allows the method to be designed in such a way that the transverse differential is locked even before the transverse differential waiting time has elapsed if a high differential speed gradient occurs. This may limit an increase in the differential speed of the transverse differential in question. The load on the switching element for locking the transverse differential may be reduced.

In another embodiment of the method, the method may include reducing a drive torque of the engine when a reduction condition is met, which is met at least when one of the differential speeds reaches or exceeds a reduction limit value. The method may be set up to detect the drive torque of the engine, for example via a torque sensor. This prevents excessive switching loads, for example on the switching elements of the differentials.

In a further embodiment of the method, the drive device may comprise a respective switching element for locking one of the longitudinal differential and the at least two transverse differentials. The method may include ascertaining a temperature of the switching elements, for example each of the switching elements, via the sensor device. The method may include limiting a lock of at least one of the longitudinal differential and the transverse differentials when the temperature of one of the switching elements reaches or exceeds a limiting value.

The method may be set up to ascertain a temperature of the switching elements or components thereof, for example via temperature sensors. The method may be configured to limit a switching operation of one of the differentials to a maximum differential speed. The method may be set up to limit the differential, for example the longitudinal differential or one of the transverse differentials, whose switching element reaches a temperature that is equal to or higher than the limitation limit value. If the differential speed exceeds the maximum differential speed, the method for preventing or limiting a switching operation, for example locking the differential, for example the longitudinal differential or one of the transverse differentials, can be set up. These method steps are particularly applicable if the switching element is designed as a multi-plate clutch. Then the method for ascertaining a fluid temperature, for example oil temperature, can be set up. This prevents the differentials and their components from overheating.

In a further embodiment of the method, the method may further comprise opening at least one of the longitudinal differential and the transverse differentials for which an opening condition is satisfied. The opening condition may be met at least when the longitudinal differential is closed for a longitudinal lock duration and/or the transverse differential is closed for a transverse lock duration.

The method may be set up to detect the steering angle, for example via the angle sensor. The steering angle may be formed by a bend angle or swivel angle of an articulated joint between a front section and a rear section of the working machine. The opening condition may be met when a steering angle reaches or exceeds a limit value. This may reduce or prevent locking of the longitudinal differential and/or transverse differentials at large steering angles. At low steering angles, the longitudinal lock duration and/or transverse lock duration may be increased. The opening condition may be met when the vehicle speed reaches or exceeds a threshold value. This prevents or reduces locking of the longitudinal differential and transverse differentials at high vehicle speeds. Restriction of the maneuverability of the working machine is reduced.

In a second aspect, a control device is provided for executing a method according to one of the preceding embodiments. Further characteristics, effects, and advantages for the second aspect can be derived from the first aspect. Furthermore, the characteristics, effects, and advantages of the second aspect represent characteristics, effects, and advantages for the first aspect. The control device may have an input interface and an output interface. The input interface may be configured to receive system information, for example at least one operating parameter, such as a rotational speed of one of the output elements, a temperature of one of the switching elements, a torque of the drive shaft, or the like. The output interface can be configured to output signals for controlling the switching elements of the longitudinal differentials and the transverse differentials.

In a third aspect, a drive device with a control device according to the second aspect is provided. Further characteristics, effects, and advantages for the third aspect can be found in one of the preceding aspects. Furthermore, the characteristics, effects, and advantages of the third aspect represent characteristics, effects, and advantages for the preceding aspects. The drive device has an engine for providing a driving force. The drive device has at least one lockable longitudinal differential. The drive device has at least two lockable transverse differentials. The longitudinal differential is designed to distribute the drive force of the engine to at least two transverse differentials. Each transverse differential is designed to distribute the drive force from one input element to two output elements. The drive device has a sensor device for detecting a plurality of operating parameters. The operating parameters include the rotational speed of the output elements of the transverse differentials.

The drive device may have several drivable axle units. The drive device may have two drivable axle units, for example a drivable front axle and a drivable rear axle. The drive device may have three axle units, for example, an additional second drivable rear axle. The drive device may have at least one longitudinal differential and two transverse differentials. The drive device may comprise a longitudinal differential and three transverse differentials. The drive device may have two longitudinal differentials and three transverse differentials. Each of the longitudinal differentials and transverse differentials may have one input element and two output elements. The output elements of the transverse differentials can be set up for a mechanical connection, for example, via at least one of a portal gearbox and a drive shaft, with a traction element. The portal gearbox may comprise at least one of a spur gear set and a planetary gear set. The portal gearbox can be located in the area of a wheel hub. The portal gearbox can be designed as a wheel hub gearbox.

In a fourth aspect, a working machine with a drive device according to the third aspect is provided. Further characteristics, effects, and advantages for the fourth aspect can be derived from the preceding aspects. Furthermore, the characteristics, effects, and advantages of the fourth aspect represent characteristics, effects, and advantages for the preceding aspects. The working machine has at least four traction elements, each of which is mechanically connected to one of the output elements of the at least two transverse differentials in order to move the working machine.

The working machine may be designed as an articulated dump truck. The working machine may have an articulated joint for steering the working machine. The front section may be pivoted relative to the rear section via the articulated joint, for example via a hydraulic or pneumatic steering system. The front section may have a drivable front axle. The rear section may have at least one drivable rear axle, for example two drivable rear axles.

Each of the traction elements may be mechanically connected, for example via at least one of a portal gearbox and a drive shaft, to an output element of one of the transverse differentials. A traction element may be designed as a drive wheel or a crawler track.

### BRIEF DESCRIPTION OF THE FIGURES

FIG. 1 is a top view of a schematic representation of an embodiment of a working machine with a drive device.

FIG. 2 is a schematic representation of an embodiment of a method for controlling the drive device.

FIG. 3 is a diagram showing the temporal progression of operating parameters of the working machine during execution of the method.

FIG. 4 is a schematic representation of an embodiment of a control device for carrying out the method.

### DETAILED DESCRIPTION AND EMBODIMENTS

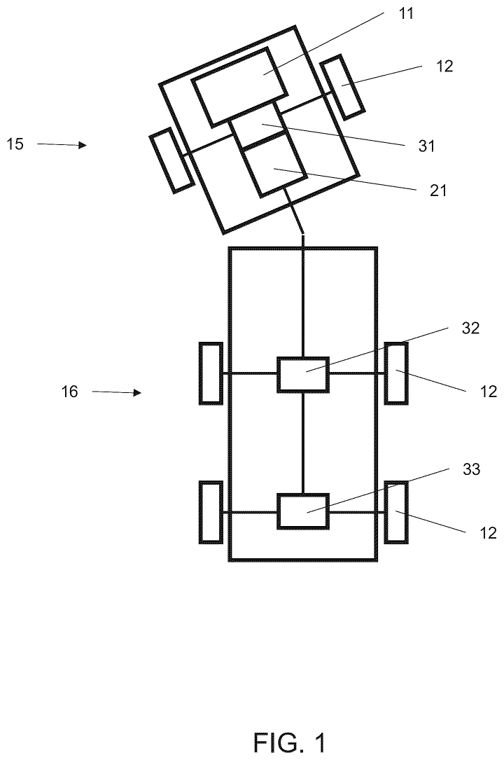

FIG. 1 is a top view of a schematic representation of an embodiment of a working machine with a drive device. The working machine is designed as an articulated dump truck. The working machine has a front section 15 and a rear section 16, which are connected to each other via an articulated joint for steering the working machine. The rear section 16 has two axle units, in this case a first drivable rear axle and a second drivable rear axle. The front section 15 has an axle unit, in this case a drivable front axle, and an engine 11. The front section 15 has a longitudinal differential 21 with one input element and two output elements. A drive shaft of the engine 11 is mechanically connected to the input element of the longitudinal differential 21 to transmit drive power. The longitudinal differential 21 is designed to distribute the drive force between its two output elements.

The drive device has three transverse differentials 31, 32, 33, each with one input element and two output elements. Each of the transverse differentials 31, 32, 33 is designed to distribute a driving force from its input element to its two output elements. The drivable front axle has a first transverse differential 31. The first drivable rear axle has a second transverse differential 32. The second drivable rear axle has a third transverse differential 33. An output element of the longitudinal differential 21 is mechanically connected to the input element of the first transverse differential 31. The other output element of the longitudinal differential 21 is mechanically connected to the input element of the second transverse differential 32 via a drive shaft arrangement. The first rear axle is designed as a through-drive axle and has a through-drive output element. The through-drive output element is mechanically connected to an input element of the third transverse differential 33. Each of the output elements of the transverse differentials 31, 32, 33 is mechanically connected to a traction element 12, in this case a drive wheel.

The drive device has a sensor device. The sensor device has a speed sensor for each output element of the transverse differentials 31, 32, 33 for detecting the speed of the respective output element. Each of the longitudinal differential 21 and the transverse differentials 31, 32, 33 is designed to be lockable via a switching element. The switching element is designed as a multi-plate clutch and can be locked continuously via a hydraulic actuator. The sensor device has a temperature sensor for each switching element to detect the temperature of the switching element and a pressure sensor to detect a locking pressure p1, p2.

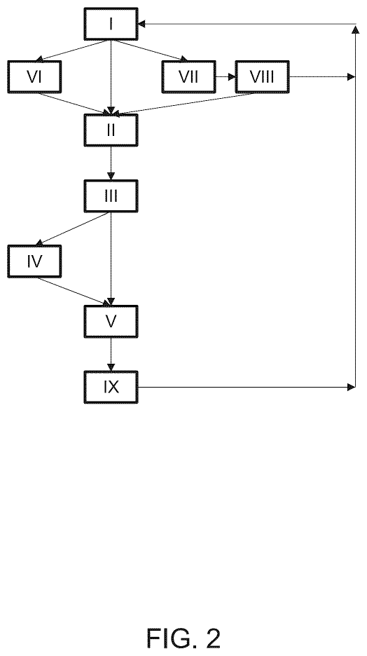

FIG. 2 is a schematic representation of an embodiment of a method for controlling the drive device. The method comprises, in a first step I, determining a differential speed dn between the speeds of the output elements of each of the transverse differentials 31, 32, 33. This determines three differential speeds dn in the method, one each for the first transverse differential 31, the second transverse differential 32, and the third transverse differential 33. In a further step II, the method comprises ascertaining a differential speed gradient dn/dt of the differential speeds dn. This determines three differential speed gradients dn/dt in the method, one each for the first transverse differential 31, the second transverse differential 32, and the third transverse differential 33.

The method comprises, in a further step VI, reducing a drive torque of the engine 11 when one of the differential speeds dn reaches or exceeds a reduction limit value. The drive torque of the engine 11 is detected by a torque sensor of the sensor device.

The method comprises, in a further step VII, ascertaining a temperature of each of the switching elements via the sensor device. The method further comprises limiting VIII the locking III, IV of at least one of the longitudinal differential 21 and the transverse differentials 31, 32, 33 to a maximum differential speed when the temperature of one of the switching elements reaches or exceeds a limiting value.

In a further step III, the method comprises locking the longitudinal differential 21 when one of the differential speeds dn reaches or exceeds a lock threshold value x1 for a longitudinal differential waiting time t1. The lock III of the longitudinal differential 21 is only executed if Lock III was not prevented in one of the previous steps.

The method comprises, in a further step V, locking the transverse differential 31, 32, 33, whose differential speed dn satisfies the longitudinal differential lock condition for a transverse differential waiting time t2, i.e., for which the differential speed dn for the longitudinal differential waiting time t1 and the transverse differential waiting time t2 reaches or exceeds the lock threshold value x1. In a further step IV, the method comprises reducing the transverse differential waiting time t2 to a reduced transverse differential waiting time t3 when the differential speed gradient dn/dt reaches or exceeds a gradient lock threshold value.

The method comprises, in a further step IX, opening the longitudinal differential 21 when the longitudinal differential 21 is closed for a longitudinal locking period, and opening IX the transverse differential 31, 32, 33, which is closed for a transverse locking period.

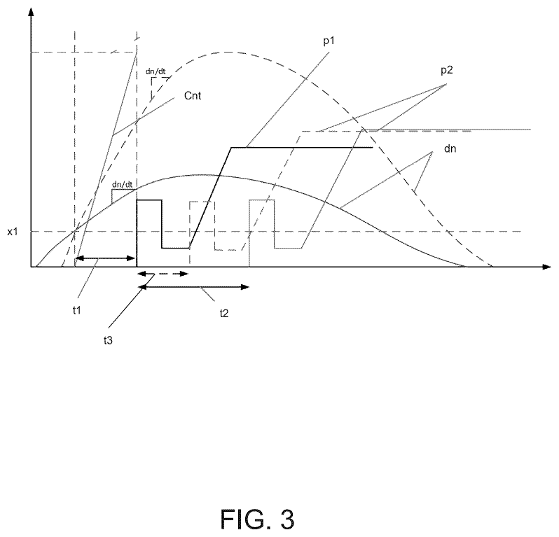

FIG. 3 is a diagram showing the temporal progression of operating parameters of the working machine during execution of the method. The diagram shows the operating parameters over time for two different situations. In the first situation, the differential speed dn increases moderately. This situation is represented by the solid curve of the differential speed dn. In the second situation, the differential speed dn increases significantly. The second situation is represented by the dashed curve of the differential speed dn.

First, the initial situation is described. The differential speed dn of one of the transverse differentials 31, 32, 33 increases moderately from 0 until the lock threshold value x1 is reached. From this point on, a counter Cnt begins to measure the time for which the differential speed dn exceeds the lock threshold value x1. After the longitudinal differential waiting time t1 has elapsed, a locking pressure p1 for actuating the switching element for the longitudinal differential 21 is increased to a pre-pressure and then reduced again slightly to a holding pressure. This gently initiates the locking of the longitudinal differential 21. After a short time, the locking pressure p1 for actuating the switching element for the longitudinal differential 21 is increased to a target pressure for locking the longitudinal differential 21. This reduces the differential speed gradient dn/dt and reduces an increase in the differential speed dn.

After the longitudinal differential waiting time t1 and the transverse differential waiting time t2 have elapsed, a locking pressure p2 for the transverse differential 31, 32, 33 is increased and then lowered again slightly. This applies holding pressure and gently initiates locking of the transverse differential 31, 32, 33. After a short period of time, the locking pressure p2 for actuating the switching element for the transverse differential 31, 32, 33 is increased to a level that locks the transverse differential 31, 32, 33. This further reduces the differential speed gradient dn/dt and reduces the differential speed dn to 0.

The second situation differs from the first situation in that the differential speed gradient dn/dt is higher than in the first situation and exceeds a gradient lock threshold value. Therefore, the transverse differential waiting time t2 is reduced to a reduced transverse differential waiting time t3. After the longitudinal differential waiting time t1 has elapsed, the transverse differential 31, 32, 33 closes more quickly than in the first situation. Due to the high differential speed gradient dn/dt, the differential speed dn of the transverse differential 31, 32, 33 reaches significantly higher values than the differential speed dn in the first situation.

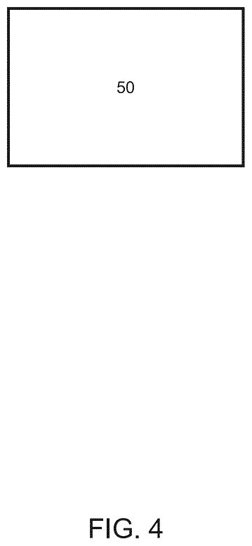

FIG. 4 is a schematic representation of an embodiment of a control device 50 for executing the method. The control device 50 has an input interface and an output interface. The input interface is designed to receive the rotational speeds of the output elements, the temperature of the switching elements, and the torque of the drive shaft. The output interface is designed to control the switching elements of the longitudinal differential 21 and the transverse differentials 31, 32, 33.

### REFERENCE NUMBERS

11 engine
12 traction element
15 Front section
16 Rear section
21 longitudinal differential
31 transverse differential, first transverse differential
32 transverse differential, second transverse differential
33 transverse differential, third transverse differential
50 control device
t1 longitudinal differential waiting time
t2 transverse differential waiting time
t3 reduced transverse differential waiting time
p1 locking pressure for the longitudinal differential
p2 locking pressure for the transverse differential
x1 lock threshold value
dn differential speed
dn/dt differential speed gradient
Cnt counter
I Determining the differential speed
II ascertaining the differential speed gradient
III locking the longitudinal differential
IV reducing the transverse differential waiting time
V locking the transverse differential
VI reducing the drive torque
VII ascertaining the temperature
VIII restricting a lock
IX opening at least one of the longitudinal differential and the transverse differentials

1. A method for controlling a drive device for a working machine, comprising:
providing the drive device comprising:
an engine (11) for providing a driving force;
at least one lockable longitudinal differential (21) for distributing the driving force of the engine (11) to at least two lockable transverse differentials (31, 32, 33), each transverse differential (31, 32, 33) being designed to distribute the driving force from an input element to two output elements, and the output elements being arranged to drive the working machine; and
a sensor device for detecting a plurality of operating parameters, which include a rotational speed of the output elements of the transverse differentials (31, 32, 33);
determining a differential speed (dn) between the rotation speeds of the respective output elements of the at least two transverse differentials (31, 32, 33);
determining that at least one differential speed (dn) reaches or exceeds a lock threshold value (x1), thereby determining that a longitudinal differential lock condition is met; and
locking the longitudinal differential (21).

2. The method according to claim 1, wherein determining that the at least one differential speed (dn) reaches or exceeds a lock threshold value (x1) includes determining that at least one differential speed (dn) exceeds the lock threshold value (x1) for a longitudinal differential waiting time (t1).

3. The method according to claim 1, comprising:
locking one of the transverse differentials (31, 32, 33) for which the transverse differential lock condition is satisfied for the transverse differential waiting time (t2).

4. The method according to claim 3, comprising:
ascertaining a differential speed gradient (dn/dt) of the differential speed (dn) of respective transverse differentials;
determining that the differential speed gradient (dn/dt) reaches or exceeds a gradient lock threshold value; and
reducing the transverse differential waiting time (t2) to a reduced transverse differential waiting time (t3).

5. The method according to claim 1, comprising:
Determining that at least one differential speed (dn) reaches or exceeds a reduction limit value, thereby satisfying a reduction condition; and
reducing a drive torque of the engine (11).

6. The method according to claim 1, wherein the drive device has a respective switching element for locking the at least one lockable longitudinal differential (21) and each of the at least two transverse differentials (31, 32, 33), wherein the method further comprises:
ascertaining a temperature of the respective switching element via the sensor device;
Determining that a temperature of one of the respective switching element reaches or exceeds a restriction limit value; and
restricting locking (III, IV) of at least one of the at least one lockable longitudinal differential (21) and the transverse differentials (31, 32, 33).

7. The method according to claim 1, comprising:
determining that the at least one lockable longitudinal differential (21) is closed for a longitudinal lock duration (t4) and/or that the transverse differential is closed for a transverse lock duration (t5), thereby determining that an opening condition is fulfilled; and
opening at least one of the at least one lockable longitudinal differential (21) and the transverse differentials (31, 32, 33) for which the opening condition is fulfilled.

8. A control device (50) configured to perform the method according to claim 1.

9-10. (canceled)

11. A drive device for a working machine, comprising:
an engine (11) configured for providing a driving force;
at least one lockable longitudinal differential (21) configured for distributing the driving force of the engine (11) to at least two lockable transverse differentials (31, 32, 33), each transverse differential (31, 32, 33) being designed to distribute the driving force from an input element to two output elements, and the output elements being arranged to drive the working machine;
a sensor configured for detecting a plurality of operating parameters, which include a rotational speed of the output elements of the transverse differentials (31, 32, 33); and
a control unit configured to perform the following method:
determining a differential speed (dn) between the rotation speed of the respective output elements of the at least two transverse differentials (31, 32, 33);
determining that at least one differential speed (dn) reaches or exceeds a lock threshold value (x1), thereby determining that a longitudinal differential lock condition is met; and
locking the longitudinal differential (21).

12. A working machine comprising:
the drive device according to claim 11; and
at least four traction elements (12) mechanically connected to one of the output elements of the at least two transverse differentials (31, 32, 33), thereby configured to move the working machine.
